(19) United States
(12) Patent Application Publication
(10) Pub. No.: US 2006/0092428 A1
(43) Pub. Date: May 4, 2006

(54) Position measuring system

(76) Inventors: Wolfgang Holzapfel, Obing (DE); Siegfried Reichhuber, Stein a.d. Traun (DE); Herbert Huber-Lenk, Nussdorr/Sondermoning (DE); Joerg Drescher, Riedering (DE)

Correspondence Address: KENYON & KENYON LLP, ONE BROADWAY, NEW YORK, NY, 10004, US

(21) Appl. No.: 11/265,967

(22) Filed: Nov. 2, 2005

(30) Foreign Application Priority Data
Nov. 3, 2004 (DE) 10 2004 053 082.3

(51) Int. Cl. G01B 11/14; G01B 11/02

(52) U.S. Cl. 356/499; 356/616

(57) ABSTRACT

A position measuring system for determining the relative position of two objects includes a power supply unit for generating a variable operating current for a laser light source. At least one photodetector generates position-dependent output signals from the light received from the laser light source. In measurement operation, the power supply unit provides a direct current having a superimposed alternating current component to the laser light source.

### CROSS-REFERENCE TO RELATED APPLICATIONS

The present application claims priority to Application No. 10 2004 053 082.3, filed in the Federal Republic of Germany on Nov. 3, 2004, which is expressly incorporated herein in its entirety by reference thereto.

### FIELD OF THE INVENTION

The present invention relates to a position measuring system having a laser light source. Such position measuring systems may be used to measure the relative position of two objects moving with respect to each other.

### BACKGROUND INFORMATION

Highly accurate optical position measuring systems have become indispensable in many areas of technology. When highest accuracy is concerned, position measuring systems based on optical scanning principles are ahead by a large margin of other, for example, magnetic, capacitive or inductive scanning principles. In applications such as photolithography, for example, position measurements in the nanometer range may be required. It has been possible to achieve such accuracies only with the aid of interferometers. Position measuring systems based on the scanning of an optical measuring scale may also advance into these regions. Such interferential measuring systems have been conventional as three-grating measuring systems. At a splitting grating, light from a light source is split into different orders of diffraction, which are reflected at a measuring scale grating and are cast onto a combination grating, where rays of different orders of diffraction are combined with each other and are made to interfere. For this purpose, the splitting grating and the combination grating may take the form of separate gratings (e.g., if the measuring scale is translucent) or as a single grating (e.g., if the measuring scale is reflecting). Even if in the second case only two gratings are physically present, the first, splitting grating simultaneously acts as a combination grating. Such a system is therefore also rightfully referred to as a three-grating measuring system. The provision of two or three gratings for a three-grating measuring system has nothing to do with the actual measuring principle and may be decided by the designer according to arbitrary criteria such as, for example, restrictions in the ray guidance or in the space available in the scanning head.

The different interfering ray bundles are detected by photo detectors and thus position-dependent detector signals that are out of phase with respect to each other are output. Since the scanning signals of such an interferential measuring system are largely free of harmonic waves, they are very well suited for interpolation. Using a measuring scale graduation in the micrometer range, the frequency multiplication effected by the interference of different orders of diffraction and a, e.g., 4096-fold subdivision of the scanning signals, it may be possible to achieve accuracies in the nanometer range.

Interferential measuring systems may be arranged such that the interfering ray bundles propagate from their splitting to their combination through path lengths that are as equal as possible. The interference of the ray bundles thus occurs at a phase difference, which in an ideal case does not depend on the wavelength of the light source. The position value is ascertained from the phase difference such that this also does not depend on the wavelength. In practice, however, there may be component, installation and adjustment tolerances, which result in small differences in path length. The output position value thus slightly depends on the wavelength of the light source. For highly accurate measuring systems, which require a measurement of the phase difference at a very high resolution, a light source having a light wavelength that is as constant as possible may therefore need to be used.

In addition, a high intensity of the light source may be important in order to be able to generate high signal strengths at minimal noise levels. This is true particularly for measuring devices which have light sources coupled via optical waveguides.

In the case of measuring devices having longer ray paths, the installation-related differences in path length of the interfering ray bundles can reach a magnitude at which the coherence length of the light source becomes significant. Only with a sufficient coherence length is it possible in these instances to keep the installation tolerances within acceptable limits.

In the case of interferential position measuring systems of the highest resolution, laser diodes may be provided as light sources. Single-mode laser diodes, which due to their high intensity and great coherence length may actually be well suited, may have certain shortcomings for position measuring systems. In certain operating states (depending especially on the operating current and on the temperature of the laser diode), mode jumps may occur which result in a sudden change in the wavelength. In a highly accurate position measuring system, however, such a change in the wavelength results in a jumping of the position measurement and frequently also in a miscounting of an incremental counter.

In order to avoid such problems, U.S. Pat. No. 4,676,645 and U.S. Pat. No. 5,000,542 provide for the use of multi-mode laser diodes, which have modes that are very close to one another. In this manner, several modes are occupied in every operating state, the occupation of the modes being continuously redistributed with a change of the operating state such that there are no great jumps in the centroid wavelength of the laser diode. Multi-mode laser diodes, however, are available only for smaller light outputs (<3 to 5 mW). In principle, laser diodes exhibit a single-mode behavior at higher light outputs. Measuring systems that require a high light output thus may not be equipped with multi-mode laser diodes.

Such multi-mode laser diodes may also be less well suited for applications requiring a great coherence length. Their use rather may require tightly toleranced mechanical and optical components in order to obtain an interference signal at all on account of the short coherence length of multi-mode laser diodes. Such position measuring systems may therefore be intricate in their manufacture and thus expensive.

Japanese Published Patent Application No. 2002-39714 provides for an interferometer to use a single-mode laser diode, which is supplied by a variable operating current. A mode-jump control device consistently readjusts (periodically or upon request) the operating current such that the laser diode is operated at an operating point that is as far as possible removed from a mode-jump point. For this purpose, in a mechanically fixed measuring system, mode jumps as a function of the operating current are detected by an irreversibly jumping position output signal and the operating current is then selected such that it is centrally between two mode jumps, that is, with the highest possible distance from the adjacent mode jumps. The consistently required measurement of the position of the mode jumps and the interruption of the actual measuring operation required for the mode jump detection, however, may be very complex and may not allow for a continuous position measurement.

German Published Patent Application No. 102 35 669 describes a position measuring system having a light source in the form of a single-mode laser light source. In order to overcome the described disadvantages of this laser light source, the use of a feedback device is provided. The laser light source and the feedback device interact with each other such that several closely adjacent modes in the laser light source are activated, thus resulting in a quasi-multi-mode operation of the single-mode laser light source. However, if a laser diode is used as a laser light source, then the interaction of the feedback device with the laser diode may result in spontaneous, short-term intensity drops and wavelength fluctuations, which are also referred to as low frequency fluctuations (LLFs) or dropouts. They are equal to mode jumps in their effect and may make an accurate position measurement very difficult.

### SUMMARY

Example embodiments of the present invention may avoid problems associated with mode jumps of a laser light source in a simple manner.

According to an example embodiment of the present invention, a position measuring system for determining the relative position of two objects includes a power supply unit for generating a variable operating current for a laser light source. At least one photodetector generates position-dependent output signals from the light received from the laser light source. In measurement operation, the power supply unit provides a direct current having a superimposed alternating current component to the laser light source.

In order to avoid problems associated with suddenly occurring wavelength fluctuations on account of mode jumps of a laser diode, mode jumps of high frequency may be obtained by force. This results in the formation of a centroid wavelength of the laser light that is relevant for the position measurement, which may change markedly less with the operating current or with the ambient temperature than in the case of a mode jump of a conventionally operated laser diode.

For the purpose of forcing a mode jump at a high frequency, the direct current for operating the laser diode, which due to the great coherence length and the high intensity may have the form of a single-mode laser diode, may have a superimposed alternating current component of a high frequency. Since a mode jump occurs as a function of the operating current, such a mode jump will occur periodically when the direct component of the operating current is so close to a mode jump point that due to the alternating component of the operating current the mode jump point is periodically covered. The closer the direct component of the operating current gets to the mode jump point, the more uniformly will both modes be occupied at an average over time. If the frequency bandwidth of the measuring system is smaller than the modulation frequency of the laser diode, then the position signals are determined only by the average over time of the two modes. Thus a slow drift of the operating current or of the ambient temperature may no longer cause a sudden change of the wavelength of the laser diode. Instead, a centroid wavelength may form, which may change markedly less quickly with the operating current or the ambient temperature in accordance with the continuous redistribution of the modes involved. This may be true particularly if several mode jumps are periodically covered at high frequency by the modulated operating current.

The coherence length of a single-mode laser diode, which is operated at an alternating current amplitude between 1 and 15 mA, is typically still approximately 100 μm to 5 mm such that the laser radiation remains capable of interference even in the millimeter range. The requirements of the mechanical adjustment and the tolerances of the mechanical and optical components thus remain within reasonable limits. Nevertheless, the reduced coherence length in comparison to conventionally operated single-mode laser diodes may help to reduce undesirable effects such as the co-modulation of stray interference branches or interferences between glass surfaces (at optical waveguide couplings, lenses, prisms, etc.).

The HF modulation of the laser diode current may additionally reduce the feedback sensitivity of a laser diode. This may be significant, particularly when the light of the laser diode must be brought to the position measuring system via an optical waveguide, for example, because no heat input is allowed at the location of the position measurement. In such an instance, the feedbacks of the optical waveguide connection may result in so-called low frequency fluctuations (LFFs), which as spontaneous, short-term losses of the light output of the laser diode may make an accurate position measurement impossible. Such LFFs are also partially suppressed by the high-frequency modulation of the laser diode current, but are also shifted into a frequency range outside of the bandwidth of the position measuring system and thus may no longer influence the measurement.

The HF modulation of the laser diode current may be particularly significant also in combination with a position measuring system, such as that described in German Published Patent Application No. 102 35 669, mentioned above. The LFFs generated there by the feedback device are suppressed or shifted and may no longer interfere with the position measurement.

To prevent beats between the scanning frequency of the photodetectors and the high-frequency modulation of the laser diode current, the scanning and the modulation in some cases may need to be synchronized so that a scanning of the photodetectors always occurs in the same phase position of the modulator. This may be done, for example, via a common timing pulse generator for both systems (position measuring system and modulator).

In order to achieve an average over time of the wavelength modulation, the modulation frequency of the alternating current component may need to be higher than the bandwidth of the sequential electronics for evaluating the shift-dependent output signals and also higher than the frequency of the output control of the laser diode (e.g., a control via a monitor photodiode).

Additional filters in the sequential electronics may suppress the residual modulation of the signals of the photodetectors. For this purpose, low-pass filters may be suitable, for example, but also higher-order filters. If the modulation frequency is sufficiently high above the bandwidth or the frequency limit of the sequential electronics of the position measuring system, then additional filters may be omitted.

The form of the alternating current component may be, e.g., square, sinusoidal, etc. Using a triangular characteristic, it may be possible to achieve a more continuous centroid wavelength shift since the individual modes are weighted in a more uniform manner.

Single-mode laser diodes, for which the HF modulation may be particularly suitable, may be constructed as index-commutated laser diodes, while multi-mode laser diodes may be amplification-commutated laser diodes. Even amplification-commutated laser diodes, however, may exhibit single-mode behavior starting at an output power of approximately 3 mW.

The use of the HF modulation of the operating current may also be a very promising possibility when using VCSEL diodes since with this diode type wavelength jumps occur as well. Although in VCSEL diodes due to the short resonator length only one single longitudinal mode may build up, wavelength jumps may occur nevertheless. In the case of VCSEL diodes, it is the transversal mode and/or the polarization direction that may change abruptly and that may also entail a corresponding wavelength change. In order to force a soft transition in this instance as well, the modulation of the diode current may be used.

The modulation of the light source current may also be used for detecting the difference in path length of the interfering light ray bundles. Such a detection may provide information regarding component, mounting and adjusting tolerances and may be used for correcting them. The difference in path length is detected with the aid of the photodetectors of the measuring system, the currents of which, however, are supplied to amplifiers that may amplify the high-frequency modulation by the light source, the bandwidth of which thus is above the modulation frequency of the diode current. The phase or position evaluation of the amplified photocell signals that may conventionally be in position measuring systems yields phase or position values that oscillate back and forth synchronous with the modulation frequency. The amplitude of this high-frequency modulation represents a direct measure for the path length difference of the interfering ray bundles. This amplitude and thus the path length difference may then be brought to zero by corrective measures on component, adjusting and/or installation tolerances.

The amplifiers used for detecting the high-frequency modulation may be integrated into a separate test instrument for the position measuring system. Alternatively, amplifiers having an appropriately high bandwidth may also be used in the measuring device itself, a low-pass filter connected in the outgoing circuit of the amplifiers suppressing the modulation of the currents of the photocells in the normal measuring mode. In the detection mode, the low-pass filters are deactivated.

A parallel processing of the modulated signals branched off in front of the low-pass and the non-modulated signals branched off behind the low-pass may also be used for controlling a single-mode laser diode. While the non-modulated signals are supplied to the usual phase or position evaluation, the modulated signals may be evaluated in a detection circuit. The latter determines the signal amplitudes oscillating at the modulation frequency of the light source. These rise when the laser diode is operated near a mode jump. Using conventional control engineering, this detection signal may be used for controlling the direct component of the laser diode current such that the laser diode may always be operated in the range that is free of mode jumps.

According to an example embodiment of the present invention, a position measurement system for determining a relative position of two objects includes: a power supply unit adapted to generate a variable operating current for a laser light source, the power supply unit adapted to supply to the laser light source, in measurement operations, a direct current having a superimposed alternating current component; and at least one photodetector adapted to generate position-dependent output signals from light received from the laser light source.

The laser light source may include a single-mode laser diode.

The power supply unit may include a laser diode drive and an HF modulator.

A frequency of the alternating current component may be between 1 MHz and 1,000 MHz.

An amplitude of the alternating current component may be greater than 10% of the direct current having the superimposed alternating current component.

A frequency of the alternating current component may greater than a bandwidth of sequential electronics for generating a position signal from the position-dependent output signals.

The position measurement system may include sequential electronics adapted to generate a position signal from the position-dependent output signals, and a frequency of the alternating current component may be greater than a bandwidth of the sequential electronics.

The single-mode laser diode may be connected to a feedback device adapted to force the single-mode laser diode into a multi-mode operation.

The position measurement system may include a feedback device connected to the single-mode laser diode, and the feedback device may be adapted to force the single-mode laser diode into a multi-mode operation.

The feedback device may include an optical waveguide, and a length of the optical waveguide may form an external resonator to activate a plurality of laser modes in the single-mode laser diode.

The at least one photodetector may be adapted to generate position-dependent output signals from light that is fed by optical waveguides to the at least one photodetector.

An HF modulator of the power supply unit and the sequential electronics may be mutually synchronized.

According to an example embodiment of the present invention, a position measurement system for determining a relative position of two objects include: a laser light source; a power supply unit adapted to generate a variable operating current for the laser light source, the power supply unit adapted to supply to the laser light source, in measurement operations, a direct current having a superimposed alternating current component; and at least one photodetector adapted to generate position-dependent output signals from light received from the laser light source.

According to an example embodiment of the present invention, a position measurement system for determining a relative position of two objects includes: power supply means for generating a variable operating current for a laser light source, the power supply unit for supplying to the laser light source, in measurement operations, a direct current having a superimposed alternating current component; and at least one photodetecting means for generating position-dependent output signals from light received from the laser light source.

According to an example embodiment of the present invention, a method for compensating for a difference in path length of interfering light ray bundles in a position measurement system that includes a power supply unit adapted to generate a variable operating current for a laser light source, the power supply unit adapted to supply to the laser light source, in measurement operations, a direct current having a superimposed alternating current component, and at least one photodetector adapted to generate position-dependent output signals from light received from the laser light source, includes: feeding the position-dependent output signals of the at least one photodetector to an amplifier having a bandwidth that is above a frequency of the alternating current component.

The method may include determining the difference in path length in accordance with an amplitude of a high-frequency phase modulation derived from the position-dependent output signals of the at least one photodetector.

The method may include minimizing an amplitude of a high-frequency modulation derived from the position-dependent output signals of the at least one photodetector and the difference in path length of the interfering light ray bundles by mechanically adjusting the position measurement system.

Further aspects and details of example embodiments of the present invention are described below with reference to the appended Figures.

### BRIEF DESCRIPTION OF THE DRAWINGS

FIG. 1 illustrates a position measuring system according to an example embodiment of the present invention.

FIG. 2a to 2c illustrate mode jumps as a function of the operating current.

FIG. 3a to 3c illustrate mode jumps as a function of the operating temperature.

### DETAILED DESCRIPTION

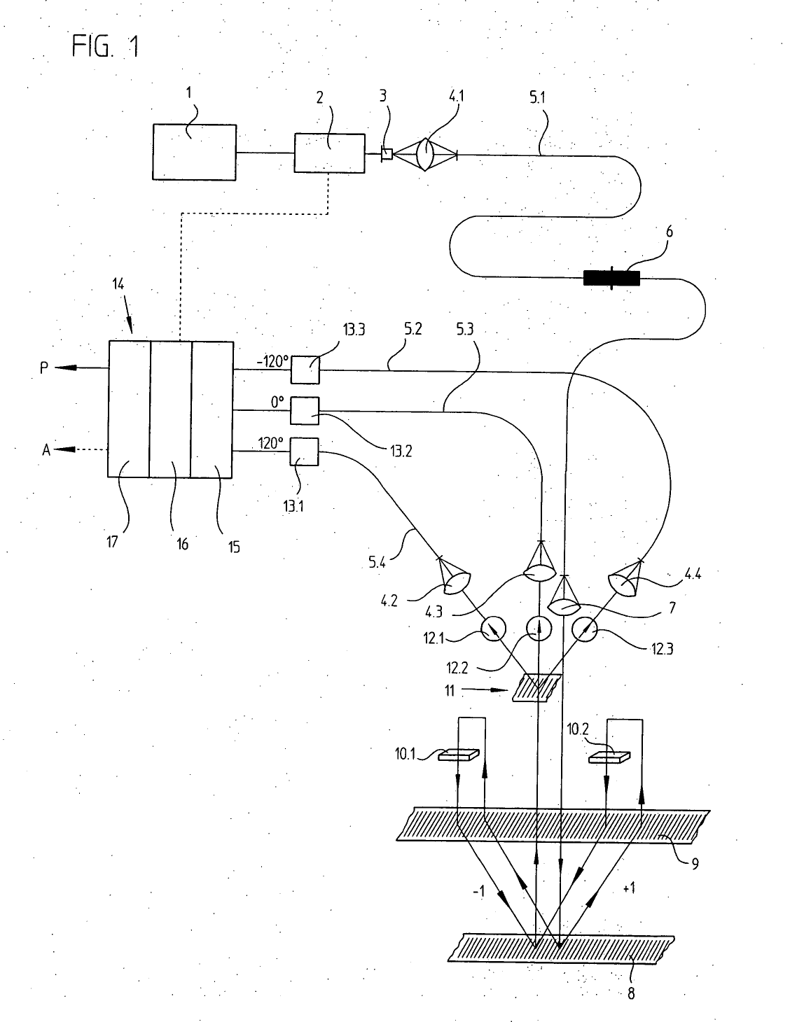

FIG. 1 illustrates an example embodiment of the present invention. Using a laser diode driver 1, the direct component of the operating current is generated for a single-mode laser diode 3, which is additionally modulated in an HF modulator 2. Laser diode driver 1 and modulator 2 together form a power supply unit for laser diode 3. Modulation frequencies between 1 and 1000 MHz, e.g., in the range of some 100 MHz, are used. A frequency range of 250 to 300 MHz may be particularly suitable. The amplitude of the modulation may be chosen such that the minimum operating current, which is also referred to as the threshold current and which is required to drive laser diode 3, is not undershot. A short-term undershooting of the minimum operating current, however, may be provided since this may cause a particularly strong excitation of laser diode 3, which may result in the oscillation build-up of additional modes. The modulation should not exceed the maximum operating current of laser diode 3 or should do so only briefly.

For a laser diode 3 having a minimum operating current of 30 mA and a maximum operating current of 70 mA, for example, an amplitude of 10 mA may be provided if laser diode 3 is operated at a direct component of the operating current of 50 mA. The minimum and maximum operating current of laser diode 3 defines its operating range. The amplitude of the alternating current component may amount to more than 10% of the direct current having the superimposed alternating current. In the mentioned example, the modulation ranges between 40 and 60 mA such that about half of the operating range of laser diode 3 is covered. Thus many modes are simultaneously activated, and the change of the centroid wavelength with the operating current or with the temperature may turn out to be particularly small.

The light of laser diode 3 is coupled by a focusing lens 4.1 into an optical waveguide 5.1, which brings the light to the actual measuring point. The use of an optical waveguide 5.1 may make it possible to avoid an input of heat at the measuring point in especially temperature-critical applications. The optical waveguide may be interrupted by one or several fiber couplers 6. Both the coupling of the laser light into optical waveguide 5.1 as well as into the fiber couplers 6 may cause reflections, which may trigger the LFFs described further above. Nevertheless, these reflections may actually be desirable and used deliberately. As described in German Published Patent Application No. 102 35 669, optical waveguide 5.1 may be arranged such that as a feedback device it interacts with single-mode laser diode 3 such that single-mode laser diode 3 is forced into multi-mode operation. For this purpose, the length of optical waveguide 5.1 is chosen such that it forms an external resonator for single-mode laser diode 3. In the process, the end of optical waveguide 5.1 facing away from laser diode 3 reflects a portion of the laser radiation back into laser diode 3. The combination of such feedback device 5.1 with the HF modulation of the operating current of single-mode laser diode 3 by modulator 2 may be particularly suitable. For the problems with mode jumps of single-mode laser diode 3 are thus already reduced by the forced multi-mode operation. The problems with LFFs produced by feedback device 5.1 may be overcome by the HF modulation of the operating current.

The light exits optical waveguide 5.1 and strikes a reflecting measuring scale 8 via a collimator lens 7. There, the light is split into two light ray bundles +1, −1 (+1st and −1st order), which form two symmetrical measuring branches. Each light ray bundle +1, −1 strikes through a scanning grating 9, is again guided onto scanning grating 9 by a reflecting prism via an λ/4 phase shifter 10.1, 10.2 and from there is again diffracted to measuring scale 8. There, the two light ray bundles +1, −1 are united into one light ray so as then to be split by a splitting grating 11 into three separate light rays, which strike through three differently oriented pole filters 12.1, 12.2, 12.3. Focusing lenses 4.2, 4.3, 4.4 couple the three light rays into optical wave guides 5.2, 5.3, 5.4, which guide the light rays to photo detectors 13.1, 13.2, 13.3. Photodetectors 13.1, 13.2, 13.3 generate three position-dependent signals −120°, 0°, +120°, each displaced in phase by 120 degrees, which may be processed by sequential electronics 14 into a position value P. The modulation of the operating current of laser diode 3 may occur in measuring operations, that is, during the detection of phase-displaced signals −120°, 0°, +120° of photodetectors 13.1, 13.2, 13.3. Only this may ensure that the negative influence of mode jumps and/or LFFs is suppressed.

Sequential electronics 14 includes an amplifier circuit 15 for amplifying phase-displaced signals −120°, 0°, +120° of photodetectors 13.1, 13.2, 13.3. An evaluation circuit 17 forms a position value P from phase-displaced signals −120°, 0 +120°, and outputs this value. An optional filter 16 may ensure that possible high-frequency residual modulations of phase-displaced signals −120, 0°, +120 do not influence the ascertainment of the position value.

Photodetectors 13.1, 13.2, 13.3 are scanned in sequential electronics 14 at a certain scanning frequency in order to provide phase-displaced signals −120°, 0°, +120° for further processing. As already mentioned, to avoid beats, it may be necessary to synchronize modulator 2 with the scanning of photodetectors 13.1, 13.2, 13.3. This is indicated in FIG. 1 by the dashed connection between modulator 2 and sequential electronics 14.

In the exemplary embodiment illustrated in FIG. 1, sequential electronics 14 also outputs the amplitude A of the high-frequency (frequency of modulator 2) phase modulation of phase-displaced signals −120°, 0°, +120°. Since this amplitude A is a measure for the path length difference of the interfering light ray bundles +1, −1, a compensation of the path length difference may be made with the aid of this amplitude A. The optical elements in the ray path may be mechanically adjusted such that amplitude A disappears or falls below a specified threshold value.

So as to be able to determine amplitude A in the evaluation circuit, position-dependent signals −120°, 0°, +120° of photodetectors 13.1, 13.2, 13.3 may need to be fed to an amplifier 15 having a bandwidth above the frequency of the alternating current component.

To determine position signal P, the amplified signals may then need to be freed by filter 16 of the high-frequency modulation at the frequency of modulator 2. This filter 16, however, does not affect the signals that are used to determine amplitude A. In evaluation electronics 14, the part that determines amplitude A may need to have a sufficient bandwidth above the modulation frequency of laser light source 3.

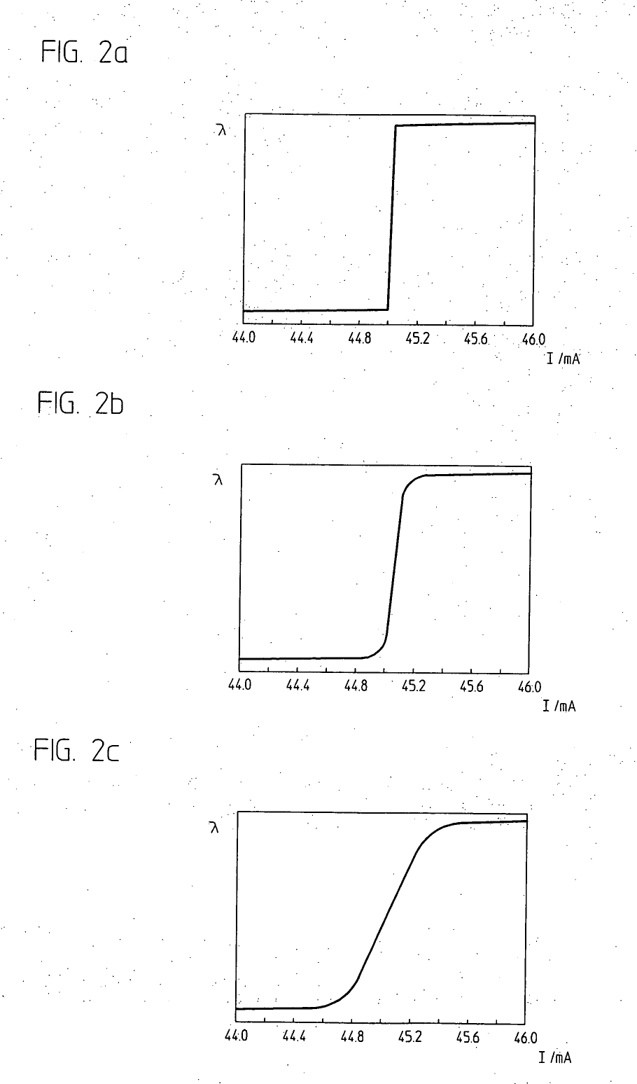

For further clarification, FIG. 2a illustrates the behavior of a single-mode laser diode without HF modulated operating current. With an increasing operating current, the wavelength of the emitted light changes only slowly until a mode jump occurs at approximately 45 mA. This results in a very distinct jump in the wavelength. If one superimposes onto the operating current an HF component of the frequency 2 MHz and the amplitude 3 mA (FIG. 2b) or 6 mA (FIG. 2c), then one sees that the mode jump is expressed in a markedly rounded rise of the wavelength. The measurements at the basis of FIGS. 2a to 2c are conducted at a constant temperature in order to demonstrate a mode jump induced by a varying operating current.

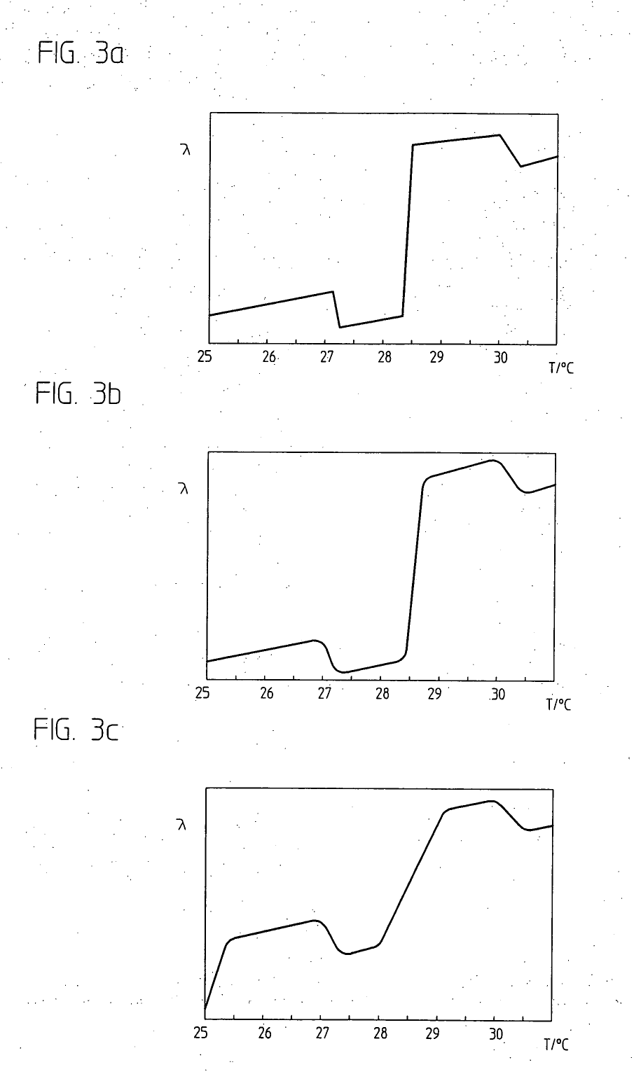

FIG. 3a illustrates mode jumps that occur at a constant operating current of the laser diode, but at a variable temperature. Here, there are even several mode jumps in the tested temperature range. Without any modulation of the operating current, the wavelength jumps are very abrupt. FIGS. 3b and 3c are based on a current modulation at 2 MHz, this time at amplitude 6 mA (FIG. 2b) or 12 mA (FIG. 2c). Again it can be seen that the wavelength jumps are clearly rounded.

The position measuring system described may have a complex optical system. In combination with this type of complex position measuring systems, the modulation of the operating current indeed may make sense especially in order to be able to perform truly highly accurate measurements without the negative influence of mode jumps and LFFs. The principle of the HF modulation of the operating current, however, may also be applied for more simple position measuring systems. Thus, for example, a measuring system for measuring the shape of a tool, which is based on the light barrier principle, may also profit from a modulated operating current. For in this instance as well, LFFs may result in the detection of an interruption of the light ray even though the laser diode used merely had a power loss. In this manner, it may be possible to measure tools such as cutters, drills, etc., at a very high resolution.

What is claimed is:

1. A position measurement system for determining a relative position of two objects, comprising:
a power supply unit adapted to generate a variable operating current for a laser light source, the power supply unit adapted to supply to the laser light source, in measurement operations, a direct current having a superimposed alternating current component; and
at least one photodetector adapted to generate position-dependent output signals from light received from the laser light source.

2. The position measurement system according to claim 1, wherein the laser light source includes a single-mode laser diode.

3. The position measurement system according to claim 1, wherein the power supply unit includes a laser diode drive and an HF modulator.

4. The position measurement system according to claim 1, wherein a frequency of the alternating current component is between 1 MHz and 1,000 MHz.

5. The position measurement system according to claim 1, wherein an amplitude of the alternating current component is greater than 10% of the direct current having the superimposed alternating current component.

6. The position measurement system according to claim 1, wherein a frequency of the alternating current component is greater than a bandwidth of sequential electronics for generating a position signal from the position-dependent output signals.

7. The position measurement system according to claim 1, further comprising sequential electronics adapted to generate a position signal from the position-dependent output signals, a frequency of the alternating current component greater than a bandwidth of the sequential electronics.

8. The position measurement system according to claim 2, wherein the single-mode laser diode is connected to a feedback device adapted to force the single-mode laser diode into a multi-mode operation.

9. The position measurement system according to claim 2, further comprising a feedback device connected to the single-mode laser diode, the feedback device adapted to force the single-mode laser diode into a multi-mode operation.

10. The position measurement system according to claim 8, wherein the feedback device includes an optical waveguide, a length of the optical waveguide forming an external resonator to activate a plurality of laser modes in the single-mode laser diode.

11. The position measurement system according to claim 1, wherein the at least one photodetector is adapted to generate position-dependent output signals from light that is fed by optical waveguides to the at least one photodetector.

12. The position measurement system according to claim 6, wherein an HF modulator of the power supply unit and the sequential electronics are mutually synchronized.

13. A position measurement system for determining a relative position of two objects, comprising:
a laser light source;
a power supply unit adapted to generate a variable operating current for the laser light source, the power supply unit adapted to supply to the laser light source, in measurement operations, a direct current having a superimposed alternating current component; and
at least one photodetector adapted to generate position-dependent output signals from light received from the laser light source.

14. A position measurement system for determining a relative position of two objects, comprising:
power supply means for generating a variable operating current for a laser light source, the power supply unit for supplying to the laser light source, in measurement operations, a direct current having a superimposed alternating current component; and
at least one photodetecting means for generating position-dependent output signals from light received from the laser light source.

15. A method for compensating for a difference in path length of interfering light ray bundles in a position measurement system that includes a power supply unit adapted to generate a variable operating current for a laser light source, the power supply unit adapted to supply to the laser light source, in measurement operations, a direct current having a superimposed alternating current component, and at least one photodetector adapted to generate position-dependent output signals from light received from the laser light source, comprising:
feeding the position-dependent output signals of the at least one photodetector to an amplifier having a bandwidth that is above a frequency of the alternating current component.

16. The method according to claim 15, further comprising determining the difference in path length in accordance with an amplitude of a high-frequency phase modulation derived from the position-dependent output signals of the at least one photodetector.

17. The method according to claim 15, further comprising minimizing an amplitude of a high-frequency modulation derived from the position-dependent output signals of the at least one photodetector and the difference in path length of the interfering light ray bundles by mechanically adjusting the position measurement system.
